(19) United States
(12) Patent Application Publication
(10) Pub. No.: US 2026/0179476 A1
(43) Pub. Date: Jun. 25, 2026

(54) ISOLATING AN EVENT DETECTION DEVICE

(71) Applicant: Honeywell International Inc., Charlotte, NC (US)

(72) Inventors: Michael Barson, Nuneaton (GB); Karthikeyan Muthukrishnan, Salem (IN); Mahadevan S B, Chennai (IN); Benjamin Henry Wolf, Leicester (GB)

(21) Appl. No.: 18/989,495

(22) Filed: Dec. 20, 2024

(51) Int. Cl. G08B 29/14; G08B 17/10

(52) U.S. Cl. CPC G08B 29/145; G08B 17/10

(57) ABSTRACT

A monitoring device for isolating an event detection device is described herein. One monitoring device includes a memory and a processor coupled to the memory, wherein the processor is configured to receive a command to enter an event detection device into a test mode, receive sensor data from the event detection device prior to, during, and subsequent to a smoke test of the event detection device performed while the event detection device is in the test mode, and reset the event detection device to cease the test mode in response to determining a smoke chamber of the event detection device is cleared of test media based on the sensor data.

### TECHNICAL FIELD

The present disclosure relates generally to isolating an event detection device.

### BACKGROUND

Large facilities (e.g., buildings), such as commercial facilities, office buildings, hospitals, and the like, may have a fire alarm system that can be triggered during an emergency situation (e.g., a fire) to warn occupants to evacuate. For example, a fire alarm system may include a fire control panel, a plurality of an event detection devices (e.g., smoke detectors) and a plurality of manual initiating devices (e.g., call points or pull stations) located throughout the facility (e.g., on different floors and/or in different rooms of the facility) that can notify occupants of the facility of a fire via alarms.

Maintaining the fire alarm system can include regular testing of event detection devices and manual initiating devices mandated by codes of practice in an attempt to ensure that the event detection devices and manual initiating devices are functioning properly. However, in order to test an event detection device, the fire alarm system is isolated and placed in a test mode.

### BRIEF DESCRIPTION OF THE DRAWINGS

FIG. 1 illustrates a block diagram of a monitoring device in accordance with an embodiment of the present disclosure.

FIG. 2 illustrates a fire alarm system in accordance with an embodiment of the present disclosure.

FIG. 3 illustrates a fire alarm system in accordance with an embodiment of the present disclosure.

FIG. 4 is a flow chart associated with testing an event detection device in accordance with an embodiment of the present disclosure.

FIG. 5 illustrates a plot of example particle data illustrating a change in a quantity of particles detected by an event detection device over time in accordance with an embodiment of the present disclosure.

FIG. 6A is a plot illustrating a change in sensor data detected by an event detection device over time in accordance with an embodiment of the present disclosure.

FIG. 6B is a plot illustrating a change in sensor data detected by an event detection device over time in accordance with an embodiment of the present disclosure.

FIG. 6C is a plot illustrating a change in sensor data detected by an event detection device over time in accordance with an embodiment of the present disclosure.

### DETAILED DESCRIPTION

A monitoring device for isolating an event detection device is described herein. One monitoring device includes a memory and a processor coupled to the memory, wherein the processor is configured to receive a command to enter an event detection device into a test mode, receive sensor data from the event detection device prior to, during, and subsequent to a smoke test of the event detection device performed while the event detection device is in the test mode, and reset the event detection device to cease the test mode in response to determining a smoke chamber of the event detection device is cleared of test media based on the sensor data.

Previous fire alarm systems require the fire alarm system or zones including a plurality of event detection devices of the fire alarm system to be isolated to test a single event detection device. This prevents the fire alarm system or the isolated zone of the fire alarm system from detecting a real fire if a fire starts during the test.

In contrast, event detection devices in accordance with the present disclosure can be placed in a test mode while the rest of the fire alarm system can remain active to detect a real fire. Accordingly, testing event detection devices in accordance with the present disclosure can help maintain the safety of the building and its inhabitants as occupants, maintenance engineers, and/or first responders can tell if a real fire event is occurring during the testing.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

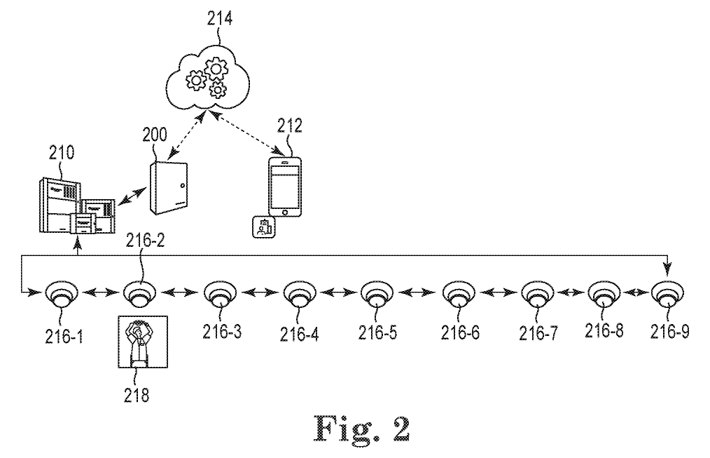

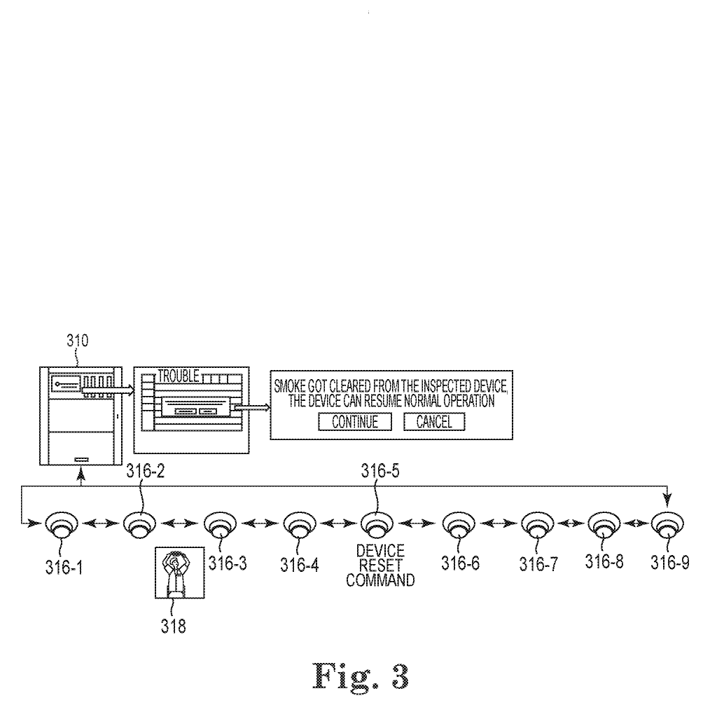

The figures herein follow a numbering convention in which the first digit or digits correspond to the drawing figure number and the remaining digits identify an element or component in the drawing. Similar elements or components between different figures may be identified by the use of similar digits. For example, 210 may reference element “10” in FIG. 2, and a similar element may be referenced as 310 in FIG. 3.

As used herein, “a”, “an”, or “a number of” something can refer to one or more such things, while “a plurality of” something can refer to more than one such things. For example, “a number of event detection devices” can refer to one or more event detection devices, while “a plurality of event detection devices” can refer to more than one event detection device.

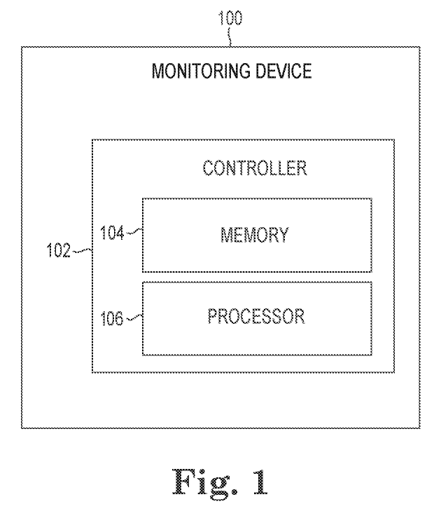

FIG. 1 illustrates a block diagram of a monitoring device 100 in accordance with an embodiment of the present disclosure. The monitoring device 100 can be, for example, a gateway device and can include a controller (e.g., microcontroller) 102.

The controller 102 can include a memory 104 and a processor 106. Memory 104 can be any type of storage medium that can be accessed by processor 106 to perform various examples of the present disclosure. For example, memory 104 can be a non-transitory computer readable medium having computer readable instructions (e.g., computer program instructions) stored thereon that are executable by processor 106 to isolate an event detection device in accordance with the present disclosure. For instance, processor 106 can execute the executable instructions stored in memory 104 to receive a command to enter an event detection device into a test mode, receive sensor data from the event detection device prior to, during, and subsequent to a smoke test of the event detection device performed while the event detection device is in the test mode, and reset the event detection device to cease the test mode in response to determining a smoke chamber of the event detection device is cleared of test media based on the sensor data. Ceasing the test mode can put the event detection device into an active mode where the event detection device can test for fires and trigger an alarm in response to detecting a fire.

Clearing the test media can include comparing a level of the test media to a threshold that triggers an alarm of the event detection device to ensure the test media does not trigger the alarm of the event detection device once the event detection device is no longer in the test mode. The test media can be smoke particles in some instances. The test media can be generated within the event detection device or external to the event detection device. For example, the test media can be generated by a particle generator and/or an air movement device of the event detection device.

The command to enter the event detection device into the test mode can be received from a mobile device. In some examples, the processor 106 can isolate the event detection device from other components of a fire alarm system in response to receiving the command to enter the event detection device into the test mode. Isolating the event detection device can include setting a mode for the event detection device to expect test media in order to test the event detection device without triggering an unwanted alarm. For example, isolating the event detection device from other components of the fire alarm system can prevent the event detection device from activating (e.g., triggering) a fire alarm of the fire alarm system in response to detecting the test media.

In a number of embodiments, the processor 106 can log a failure in response to determining the smoke chamber of the event detection device has not cleared (e.g., is not cleared of test media) based on the sensor data. The processor 106 can transmit a notification of the failure to a cloud computing device and/or a mobile device.

FIG. 2 illustrates a fire alarm system in accordance with an embodiment of the present disclosure. The fire alarm system can include a monitoring device 200, which can correspond to monitoring device 100 of FIG. 1, a fire control panel 210, a cloud computing device 214, a mobile device 212, and/or a number of event detection devices 216-1, 216-2, 216-3, 216-4, 216-5, 216-6, 216-7, 216-8, 216-9.

The mobile device 212 can be a computing device, a personal laptop computer, a smart phone, a tablet, a wrist-worn device, and/or redundant combinations thereof, among other types of computing devices. Although not illustrated in FIG. 2, in a number of embodiments, the fire control panel 210 and/or the mobile device 212 can include a user interface. The user interface can be a GUI that can provide and/or receive information to and/or from a user and/or the event detection devices 216-1,…, 216-9. The user interface can display messages and/or data received from the event detection devices 216-1,…, 216-9. For example, the mobile device 212 or the fire control panel 210 can receive a selection of event detection device 216-2 of the number of event detection devices 216-1,…, 216-9 via a user interface from a user (e.g., person) 218.

The event detection device 216-2 can be placed in a test mode in response to the selection of the event detection device 216-2. The event detection device 216-2 can be isolated from other components of the fire alarm system in response to placing the event detection device 216-1 in the test mode. The user 218 can then test event detection device 216-2 without an alarm being triggered.

Sensor data can be received from the event detection device 216-2 while the event detection device 216-2 is in the test mode. The sensor data can be received at the monitoring device 200, the fire control panel 210, the cloud computing device 214, and/or the mobile device 212. In some examples, the sensor data can be used by the monitoring device 200 to determine a smoke test is being performed on the event detection device 216-2. In response to determining that the smoke test is being performed, the event detection device 216-2 can log the smoke test and continue to be isolated from the other components of the fire alarm system. The smoke test can also be logged at the mobile device 212 and/or the fire control panel 210 in response to determining that the smoke test is being performed.

In a number of embodiments, a fire can be determined to be occurring based on the sensor data. In some examples, an alarm can be raised in response to determining the fire is occurring. For example, isolation of the event detection device 216-2 from the other components of the fire alarm system can cease in response to determining that the fire is occurring and a fire alarm can be triggered. If there is a failure to determine whether a smoke test is being performed on the event detection device 216-2 or a fire is occurring based on the sensor data, a query can be transmitted to the mobile device 212.

The event detection devices 216-1,…, 216-9, the fire control panel 210, the monitoring device 200, the cloud computing device 214, and the mobile device 212 can communicate with each other via a wired or wireless network. For example, the mobile device 212, the cloud computing device 214, the monitoring device 200, and/or the fire control panel 210 can transmit a command (e.g., to enter test mode and/or isolate) to each of the event detection devices 216-1,…, 216-9 via the network. In a number of embodiments, each of the event detection devices 216-1,…, 216-9 can transmit a report to the mobile device 212, the cloud computing device 214, the monitoring device 200, and/or the fire control panel 210 via the network, and the mobile device 212 and/or the fire control panel 210 can display the report.

The networks described herein can be a network relationship through which the event detection devices 216-1,…, 216-9, the monitoring device 200, the fire control panel 210, the cloud computing device 214, and the mobile device 212 can communicate with each other. Examples of such a network relationship can include a distributed computing environment (e.g., a cloud computing environment), a wide area network (WAN) such as the Internet, a local area network (LAN), a personal area network (PAN), a campus area network (CAN), or metropolitan area network (MAN), among other types of network relationships. For instance, the network can include a number of servers that receive information from and transmit information to the event detection devices 216-1,…, 216-9, the monitoring device 200, the fire control panel 210, the cloud computing device 214, and the mobile device 212 via a wired or wireless network.

As used herein, a “network” can provide a communication system that directly or indirectly links two or more computers and/or peripheral devices and allows a mobile device 212 to access data and/or resources on the event detection device 216-1,…, 216-9, the monitoring device 200, the fire control panel 210, the cloud computing device 214, and vice versa. A network can allow users to share resources on their own systems with other network users and to access information on centrally located systems or on systems that are located at remote locations. For example, a network can tie a number of computing devices together to form a distributed control network (e.g., cloud computing device 214).

A network may provide connections to the Internet and/or to the networks of other entities (e.g., organizations, institutions, etc.). Users may interact with network-enabled software applications to make a network request, such as to get data. Applications may also communicate with network management software, which can interact with network hardware to transmit information between devices on the network.

FIG. 3 illustrates a fire alarm system in accordance with an embodiment of the present disclosure. The fire alarm system can include a fire control panel 310, which can correspond to fire control panel 210 of FIG. 2, and/or a number of event detection devices 316-1, 316-2, 316-3, 316-4, 316-5, 316-6, 316-7, 316-8, 316-9, which can correspond to a number of event detection devices 216-1, 216-2, 216-3, 216-4, 216-5, 216-6, 216-7, 216-8, 216-9 of FIG. 2. One or more of the number of event detection devices 316-1,…, 316-9 can be included within a portion of the fire alarm system. The portion of the fire alarm system can be a zone. In the following example, event detection device 316-5 can be included within the portion of the fire alarm system.

The fire alarm system can further include a monitoring device (e.g., monitoring device 100 and 200 of FIGS. 1 and 2, respectively). The monitoring device can be a gateway device, for example. The monitoring device can be coupled to the fire control panel 310 and/or a mobile device (e.g., mobile device 212 of FIG. 2). The monitoring device can receive a command from a user 318 to initiate a test mode for the portion of the fire alarm system from the mobile device, receive sensor data from the event detection device 316-5, determine the event detection device is in the test mode based on the sensor data, prevent the event detection device from triggering a fire alarm of the fire alarm system in response to determining the event detection device is being tested, and reset the event detection device to cease the test mode in response to determining a smoke chamber of the event detection device 316-5 is cleared of test media based on the sensor data.

The monitoring device can receive a command to cease the test mode for the portion of the fire alarm system from the mobile device and reset the event detection device 316-5 to cease the test mode in response to receiving the command to cease the test mode. The fire control panel 310 can log a failure of the event detection device 316-5 to reset. The fire control panel can isolate the event detection device 316-5 from other components of the fire alarm system in response to the event detection device 316-5 failing to reset.

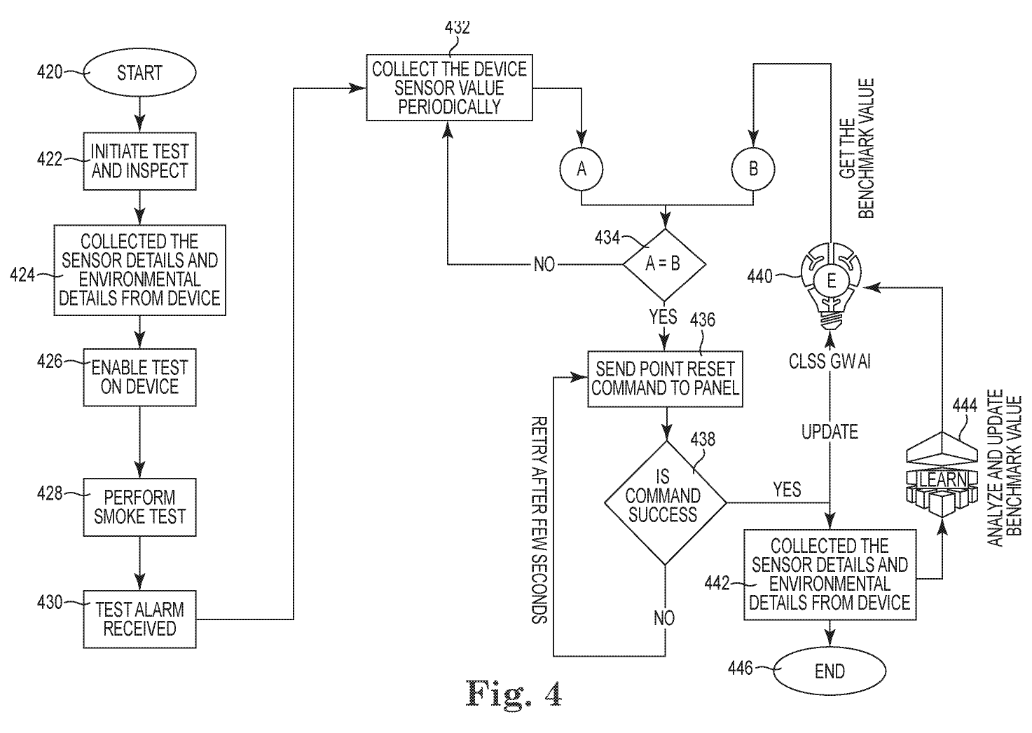

FIG. 4 is a flow chart associated with testing an event detection device in accordance with an embodiment of the present disclosure. In some embodiments, the steps of the flow chart illustrated in FIG. 4 can be performed by the event detection devices, previously described in connection with FIGS. 2 and/or 3.

At 420, the testing of the event detection device can start. In a number of embodiments a monitoring device (e.g., monitoring device 100 and 200 of FIGS. 1 and 2, respectively) can receive a command to test the event detection device. The monitoring device can receive the command from a mobile device (e.g., mobile device 212 of FIG. 2) and/or a fire control panel (e.g., fire control panel 210 and 310 of FIGS. 2 and 3, respectively).

The event detection device can initiate the test and inspect at 422. The monitoring device can transmit a command to the event detection device to initiate the test and the event detection device can initiate the test in response to receiving the command. The test can include the event detection device collecting sensor data. For example, an optical scatter chamber of the event detection device can measure a quantity of particles inside the optical scatter chamber in response to receiving the command.

At 424, the monitoring device can receive the sensor data collected by the event detection device. The sensor data can provide information about the current environment the event detection device is in.

The monitoring device can enable a test on the event detection device at 426. A command to test can be transmitted from the monitoring device to the event detection device.

At 428, the smoke test can be performed at the event detection device. The smoke test can include a user manually inserting smoke (e.g., particles) into the event detection device or the event detection device can perform a self-test. The self-test can include the event detection device generating smoke within the event detection device.

A test alarm can be received at 430. The test alarm can be received by the monitoring device. The test alarm can be triggered in response to particles measured by the event detection device reaching a threshold quantity of particles, for example.

At 432, the monitoring device can collect (e.g., receive) a sensor value periodically from the event detection device. The sensor value can be a particle count, a temperature reading, or a gas reading, for example.

The sensor value (e.g., A) can be compared to a benchmark value (e.g., B) at 434 to determine whether the testing of the event detection device is complete. If the sensor value is not equal to the benchmark value, the monitoring device can continue to collect the sensor value periodically from the event detection device at 432 as the testing of the event detection device is not complete.

If the sensor value is equal to the benchmark value, the monitoring device can send a point reset command to a fire control panel (e.g., fire control panel 210 and 310 of FIGS. 2 and 3, respectively at 436) to reset the event detection device, as the testing of the event detection device is complete. Resetting the event detection device ceases the test mode.

At 438, if the point reset command is not successful, the monitoring device can retry sending the command. For example, the monitoring device can retry sending the command after a few seconds have passed since last sending the command.

If the point reset command is successful, the sensor data from the event detection device can be collected at 442. The sensor data can be stored at the monitoring device and/or sent from the monitoring device to a cloud computing device (e.g., cloud computing device 214 of FIG. 2).

At 444, the sensor data can be analyzed and updated. In some examples, a benchmark value can be set based on the sensor data.

The benchmark value can be stored and used to perform operations on the monitoring device (e.g., gateway device) at 440. In a number of embodiments, the operations can include artificial intelligence (AI) and/or machine learning operations. The benchmark value and the sensor data can continue to be updated over time.

At 446, the testing of the event detection device can end. In some examples, the testing of the event detection device can end in response to receiving a command at the monitoring device to cease the test. For example, a user of the mobile device can select to end the test and the mobile device can transmit a command to the monitoring device to end the test in response.

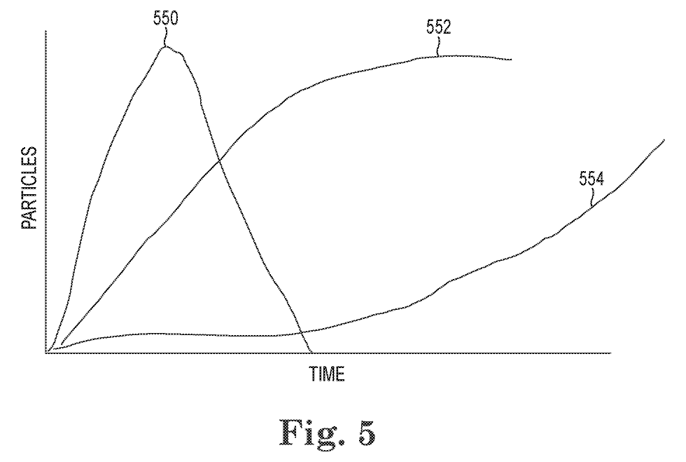

FIG. 5 illustrates a plot (e.g., graph) of example particle data illustrating a change in a quantity of particles detected by an event detection device (e.g., event detection device 216-1,…, 216-9 and 316-1,…, 316-9 in FIGS. 2 and 3, respectively) over time in accordance with an embodiment of the present disclosure. A monitoring device (e.g., monitoring device 100 and 200 of FIGS. 1 and 2, respectively) can receive the particle data from the event detection device and determine whether the event detection device is being tested.

For example, if the particle data includes a spike, including a sharp incline and a sharp decline, in the quantity of particles over a short period of time, as illustrated by line 550, the monitoring device can determine the event detection device has been tested. The sharp decline can indicate to the monitoring device that a smoke chamber of the event detection device is cleared of test media. In response, the monitoring device can transmit a command to the event detection device to cease a test mode enabling the event detection device to trigger an alarm if a fire is detected.

If the quantity of particles steadily increases and plateaus, as illustrated by line 552, the monitoring device can flag the event detection device to have a user determine whether the event detection device is detecting a fire or the event detection device is masked. An event detection device can be masked in response to something covering an inlet to the event detection device or in response to an excess of test smoke, for example. The flag can be transmitted to a mobile device (e.g., mobile device 212 of FIG. 2) of a user. The flag can include a report identifying the event detection device and/or a location of the event detection device and a plot of line 552 and/or the particle data. In a number of embodiments, the user can trigger an alarm or mark the event detection device as tested.

If the quantity of particles ramps up, as illustrated by line 554, the monitoring device can determine that the event detection device is not being tested and that the event detection device is detecting a fire. In response, the monitoring device can trigger the alarm and/or allow the event detection device to trigger the alarm.

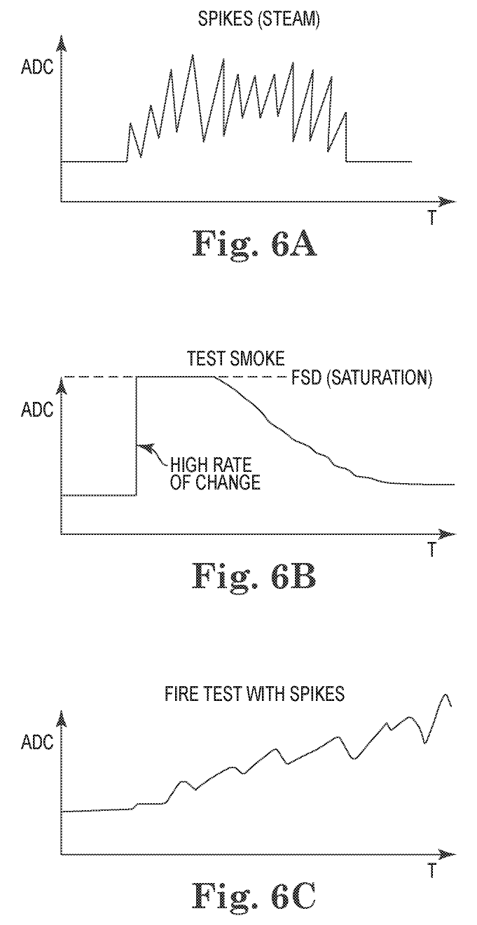

FIG. 6A is a plot illustrating a change in sensor data detected by an event detection device (e.g., event detection device 216-1,…, 216-9 and 316-1,…, 316-9 in FIGS. 2 and 3, respectively) over time in accordance with an embodiment of the present disclosure. The sensor data can be converted into an analog-to-digital converter (ADC) signal by the event detection device and transmitted to a monitoring device (e.g., monitoring device 100 and 200 of FIGS. 1 and 2, respectively).

The plot of FIG. 6A illustrates data from a sensor detecting steam being used to test the event detection device. The monitoring device can receive the data and compare this data to previous test data to determine the event detection device is being tested in response to matching at least a portion of the data to previous test data. The portion of data can include a number of spikes of an ADC signal that subside over time.

FIG. 6B is a plot illustrating a change in sensor data detected by an event detection device (e.g., event detection device 216-1,…, 216-9 and 316-1,…, 316-9 in FIGS. 2 and 3, respectively) over time in accordance with an embodiment of the present disclosure. The sensor data can be converted into an analog-to-digital converter (ADC) signal by the event detection device and transmitted to a monitoring device (e.g., monitoring device 100 and 200 of FIGS. 1 and 2, respectively).

The plot of FIG. 6B illustrates data from a sensor detecting smoke being used to test the event detection device. The monitoring device can receive the data and compare this data to previous test data to determine the event detection device is being tested in response to matching at least a portion of the data to previous test data. The portion of data can include a high rate of change of the ADC signal to a fire/smoke damper (FSD) saturation level followed by a ramped decline in the ADC signal.

FIG. 6C is a plot illustrating a change in sensor data detected by an event detection device (e.g., event detection device 216-1,…, 216-9 and 316-1,…, 316-9 in FIGS. 2 and 3, respectively) over time in accordance with an embodiment of the present disclosure. The sensor data can be converted into an analog-to-digital converter (ADC) signal by the event detection device and transmitted to a monitoring device (e.g., monitoring device 100 and 200 of FIGS. 1 and 2, respectively).

The plot of FIG. 6C illustrates data from a sensor detecting a fire test of the event detection device. The monitoring device can receive the data and compare this data to previous test data to determine the event detection device is being tested in response to matching at least a portion of the data to previous test data. The portion of the data can include an increase in the ADC signal with spikes.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A monitoring device for isolating an event detection device, comprising:
a memory; and
a processor coupled to the memory, wherein the processor is configured to:
receive a command to enter an event detection device into a test mode;
receive sensor data from the event detection device prior to, during, and subsequent to a smoke test of the event detection device performed while the event detection device is in the test mode; and
reset the event detection device to cease the test mode in response to determining a smoke chamber of the event detection device is cleared of test media based on the sensor data.

2. The device of claim 1, wherein the processor is configured to isolate the event detection device from other components of a fire alarm system in response to receiving the command to enter the event detection device into the test mode.

3. The device of claim 1, wherein the command to enter the event detection device into the test mode is received from a mobile device.

4. The device of claim 1, wherein the processor is configured to log a failure in response to determining the smoke chamber of the event detection device has not cleared based on the sensor data.

5. The device of claim 4, wherein the processor is configured to transmit a notification of the failure to a cloud computing device.

6. The device of claim 4, wherein the processor is configured to transmit a notification of the failure to a mobile device.

7. A method of isolating an event detection device, comprising:
receiving, by a mobile device or a fire control panel, a selection of the event detection device of a fire alarm system;
placing the event detection device in a test mode in response to the selection of the event detection device; and
isolating the event detection device from other components of the fire alarm system in response to placing the event detection device in the test mode.

8. The method of claim 7, further comprising receiving sensor data from the event detection device while the event detection device is in the test mode.

9. The method of claim 8, further comprising:
determining a smoke test is being performed on the event detection device based on the sensor data; and
logging the smoke test at the event detection device in response to determining that the smoke test is being performed.

10. The method of claim 9, further comprising continuing to isolate the event detection device from the other components of the fire alarm system in response to determining that the smoke test is being performed.

11. The method of claim 9, further comprising logging the smoke test at the mobile device or the fire control panel in response to determining that the smoke test is being performed.

12. The method of claim 8, further comprising:
determining a fire is occurring based on the sensor data; and
raising an alarm in response to determining the fire is occurring.

13. The method of claim 12, further comprising ceasing the isolation of the event detection device from the other components of the fire alarm system in response to determining that the fire is occurring.

14. The method of claim 12, further comprising triggering a fire alarm in response to determining that the fire is occurring.

15. The method of claim 8, further comprising:
failing to determine whether a smoke test is being performed on the event detection device or a fire is occurring based on the sensor data; and
transmitting a query to the mobile device in response to failing to determine whether the smoke test or the fire is occurring.

16. A fire alarm system, comprising:
an event detection device, wherein the event detection device is included within a portion of the fire alarm system;
a fire control panel coupled to the event detection device;
a mobile device; and
a monitoring device coupled to the fire control panel and the mobile device, wherein the monitoring device is configured to:
receive a command to initiate a test mode for the portion of the fire alarm system from the mobile device;
receive sensor data from the event detection device;
determine the event detection device is in the test mode based on the sensor data;
prevent the event detection device from triggering a fire alarm of the fire alarm system in response to determining the event detection device is being tested; and
reset the event detection device to cease the test mode in response to determining a smoke chamber of the event detection device is cleared of test media based on the sensor data.

17. The system of claim 16, wherein the portion of the fire alarm system is a zone of the fire alarm system.

18. The system of claim 16, wherein the monitoring device is configured
to:
receive a command to cease the test mode for the portion of the
fire alarm system from the mobile device; and
reset the event detection device to cease the test mode in response
to receiving the command to cease the test mode.

19. The system of claim 16, wherein the fire control panel is configured to log a failure of the event detection device failing to reset.

20. The system of claim 16, wherein the fire control panel is configured to isolate the event detection device from other components of the fire alarm system in response to the event detection device failing to reset.
